(19) United States
(12) Patent Application Publication
(10) Pub. No.: US 2004/0100585 A1
(43) Pub. Date: May 27, 2004

(54) Broadcasting receiver

(76) Inventor: Yasuyuki Ikeguchi, Hyogo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/718,555

(22) Filed: Nov. 24, 2003

(30) Foreign Application Priority Data
Nov. 25, 2002 (JP) 340435/2002

(51) Int. Cl. H04N 5/46; H04Q 1/30

(52) U.S. Cl. 348/558; 340/7.26

(57) ABSTRACT

There are provided an analog tuner for receiving analog broadcasting and a digital tuner for receiving digital broadcasting. An EPG decoder extracts EPG data in analog broadcasting, and a demultiplexer extracts EPG data in digital broadcasting. A CPU receives each of the EPG data, to judge whether or not the same program is being broadcast in analog broadcasting and digital broadcasting (whether or not there is simulcast). The CPU produces, when analog broadcasting in simulcast is being received, a message that the same program is being broadcast in digital broadcasting by an OSD circuit and displays the produced message on a screen (a CRT).

### BACKGROUND OF THE INVENTION

1. Field of the Invention

The present invention relates to a broadcasting receiver that can receive both digital broadcasting and analog broadcasting.

A digital broadcasting receiver that receives digital broadcasting using a satellite or a terrestrial wave selects an arbitrary broadcasting wave out of a plurality of broadcasting waves which are received through a dedicated antenna or a terrestrial wave antenna using a tuner, selects an arbitrary channel out of a plurality of channels included in the selected broadcasting wave using demultiplex processing, extracts a digital signal on the selected channel, and decodes the extracted digital signal, to output a video/audio signal.

Meanwhile, it seems that broadcasting enterprisers have more frequently employed simulcast for broadcasting the same program in terrestrial digital broadcasting and terrestrial analog broadcasting, for example. In this case, it is considered that broadcasting is performed by SD (Standard Definition Television) and HD (High Definition Television) in terrestrial digital broadcasting, so that programs of higher image quality can be watched in digital broadcasting, as compared with those in analog broadcasting. Some broadcasting receivers are so configured that in a case where the same program is being broadcast using simulcast in analog broadcasting and digital broadcasting, the receiving of digital broadcasting is automatically switched to the receiving of analog broadcasting when the receiving level is below a predetermined level while a digital broadcasting program is being viewed (see JP-A-2001-211126).

In such a configuration in which both a digital broadcasting wave and an analog broadcasting wave can be received, however, the same program as an analog broadcasting program currently received is being broadcast in digital broadcasting, and a user may continue to watch the analog broadcasting program of lower image quality without knowing that the same program is being broadcast in digital broadcasting. Particularly, such situations easily occur when a user views a program while channel-hopping from one to another without depending on an EPG screen.

### SUMMARY OF THE INVENTION

In view of the foregoing circumstances, an object of the present invention is to provide a broadcasting receiver capable of urging a user to view a digital broadcasting program as much as possible in a case where the same program is being broadcast using simulcast in analog broadcasting and digital broadcasting.

In order to solve the above-mentioned problem, a broadcasting receiver according to the present invention is characterized by comprising an analog broadcasting receiving unit for receiving analog broadcasting; a digital broadcasting receiving unit for receiving digital broadcasting; means for acquiring information as to whether or not the same program is being broadcast in analog broadcasting and digital broadcasting, to judge whether or not there is simulcast; and means for displaying on a screen a message that the same program is being broadcast in digital broadcasting when analog broadcasting in simulcast is being received.

In the above-mentioned configuration, the message that the same program is being broadcast in digital broadcasting when analog broadcasting in simulcast is being received is displayed on the screen. Therefore, situations where a user continues to view the program in analog broadcasting without noticing digital broadcasting in simulcast can be prevented as much as possible.

When a predetermined key is operated in a state where the message is displayed, the broadcasting receiver may be so configured that digital broadcasting in simulcast is received.

A broadcasting receiver according to the present invention is characterized by comprising an analog broadcasting receiving unit for receiving analog broadcasting; a digital broadcasting receiving unit for receiving digital broadcasting; means for acquiring information as to whether or not the same program is being broadcast in analog broadcasting and digital broadcasting, to judge whether or not there is simulcast; and means for switching, in a case where analog broadcasting in simulcast is being received, the receiving of analog broadcasting in simulcast to the receiving of digital broadcasting in simulcast when a predetermined key is operated.

Even when a user is viewing an analog broadcasting program, the user may, in some cases, think “if simultaneous broadcasting is being performed in digital broadcasting, I want to view a digital broadcasting program”. In such a case, if there is a digital broadcasting program in simulcast, a channel is automatically switched so as to receive the digital broadcasting program only by operating the predetermined key.

In a broadcasting receiver so configured that a channel can be changed by comprising a channel UP/DOWN key, a broadcasting receiver according to the present invention is characterized by comprising an analog broadcasting receiving unit for receiving analog broadcasting; a digital broadcasting receiving unit for receiving digital broadcasting; means for acquiring information as to whether or not the same program is being broadcast in analog broadcasting and digital broadcasting, to judge whether or not there is simulcast; and means for erasing an analog channel on which analog broadcasting in simulcast is being performed at the present time on the basis of an internal clock from a list in the channel UP/DOWN key.

In the above-mentioned configuration, by producing the above-mentioned list, analog broadcasting in which the same program as that in digital broadcasting is being broadcast is not tuned in to by the above-mentioned operation of the UP/DOWN key. Consequently, it is possible to prevent a program in analog broadcasting from being viewed without noticing the same program which is being broadcast in digital broadcasting.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a broadcasting receiver 30 according to the present embodiment which can receive both terrestrial digital broadcasting and terrestrial analog broadcasting;

FIG. 2 is a flow chart showing the contents of processing performed in relation to simultaneous broadcasting;

FIG. 3 is a flow chart showing the contents of processing performed in relation to simultaneous broadcasting; and

FIG. 4 is a flow chart showing the contents of processing performed in relation to simultaneous broadcasting.

### DESCRIPTION OF THE PREFERRED EMBODIMENTS

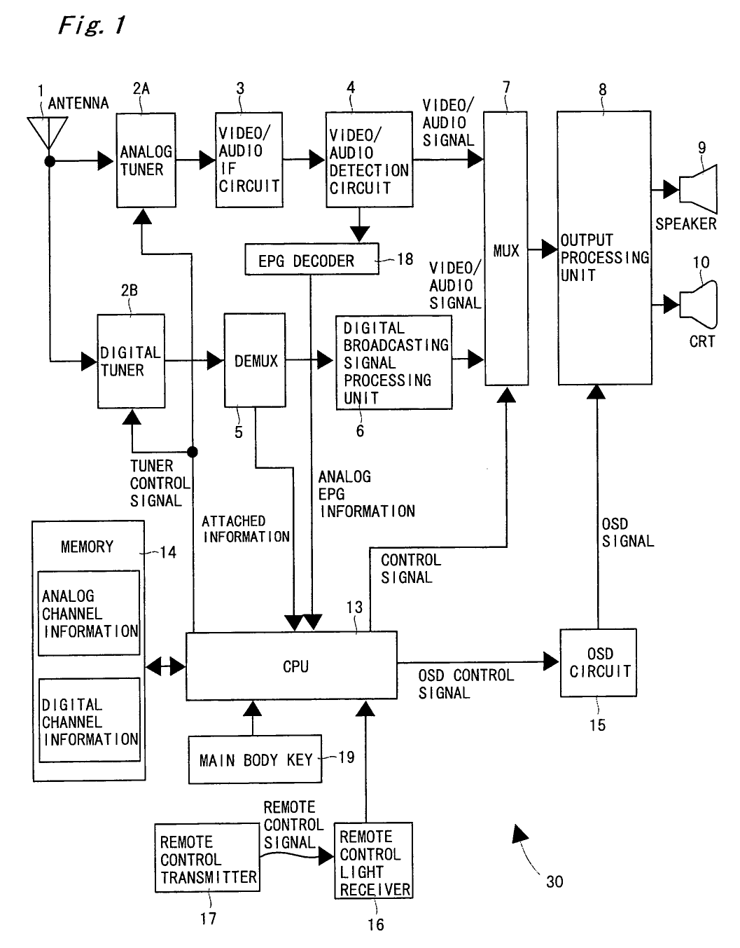

An embodiment of the present invention will be described on the basis of FIGS. 1 to 4. Here, a case where a user views programs in terrestrial digital broadcasting is illustrated.

In FIG. 1, a terrestrial wave antenna 1 is arranged in a predetermined direction outdoors, and receives a terrestrial wave broadcasting signal. The terrestrial wave antenna 1 feeds the received signal to tuners 2A and 2B.

The analog tuner 2A tunes in to radio frequencies (RF) from the antenna 1, and converts the radio frequencies into intermediate frequencies (IF). The tuner 2A comprises a first-stage amplifier for amplifying a received RF signal (a high-frequency signal), an AGC (Automatic Gain Control) amplifier for making gain variable by a control voltage from the exterior, a mixer for generating an IF signal having a frequency which is the difference between a local frequency generated by a voltage controlled oscillator and the received RF signal, a PLL (Phase-Locked Loop) circuit for controlling the voltage controlled oscillator to a state where a predetermined frequency is outputted by channel tuning data fed from the CPU 13, an intermediate frequency amplifier, and so forth. A video/audio intermediate frequency (IF) circuit 3 comprises various types of filtering circuits, and amplifies, out of the signal having intermediate frequencies outputted from the tuner 2A, the intermediate frequency in a required band with high gain. A detection circuit 4 detects a video signal having the amplified intermediate frequency to extract a color television signal (a luminance signal, a chrominance signal, a synchronizing signal), and detects an audio signal having the intermediate frequency.

An EPG decoder 18 extracts EPG data (the name of a broadcasting station, the name of a program, the time when the program begins/the time when the program ends, etc.), inserted as digital data in a vertical blanking period of a composite video signal obtained by demodulation, and feeds the extracted EPG data to the CPU 13. As an EPG service in analog broadcasting, ADAMS (TV-Asahi Data and Multimedia Service)-EPG has been

The digital tuner 2B comprises the same frequency selecting function as the above-mentioned analog tuner 2A, and comprises a demodulation circuit, an inverse interleave circuit, an error correcting circuit, and so forth, thereby demodulating the selected digital modulation signal to output a transport stream.

A demultiplexer (DEMUX) 5 separates the transport stream into a video stream and an audio stream based on MPEG2 (Moving Picture Experts Group2), PSI/SI (Program Specific Information/Service Information), and so forth. The demultiplexer 5 feeds the video stream and the audio stream to a digital broadcasting signal processing unit 6, and feeds to a CPU 13 program information or the like included in the PSI/SI. A plurality of channels are multiplexed on the transport stream. Processing for selecting any of the channels can be performed by extracting from the above-mentioned PSI/SI data indicating which packet ID in the transport stream is used to multiplex the arbitrary channel. The transport stream can be also selected on the basis of information in the PSI/SI.

The digital broadcasting signal processing unit 6 comprises a video decoder for decoding the video stream and an audio decoder for decoding the audio stream. The video decoder decodes a variable length code which has been inputted, to find a quantization factor and a motion vector, thereby carrying out inverse DCT (Discrete Cosine Transformation), motion compensation control based on the motion vector, and the like. The audio decoder decodes a coded signal which has been inputted, to produce audio data. The video data/audio data generated by the decoding is subjected to D/A (Digital-to-Analog) conversion, and is converted into a video signal/audio signal.

A multiplexer (MUX) 7 inputs a video/audio signal based on analog broadcasting and a video/audio signal based on digital broadcasting. The multiplexer 7 selects and outputs either one of the video/audio signals by an instruction from the CPU 13.

An output processing unit 8 performs processing for amplifying a luminance signal in the video signal selected and outputted in the multiplexer 7 to a size required to drive a CRT (Cathode-Ray Tube) 10, generating a chrominance sub-carrier, and demodulating a color difference signal from a carrier chrominance signal using the chrominance sub-carrier, and feeds the processed signal to the CRT 10. The audio signal selected and outputted in the multiplexer 7 is amplified and is supplied to a speaker 9. Further, the output processing unit 8 performs processing for superimposing an OSD signal outputted from an OSD (On-Screen Display) circuit 15, described later, into the received video signal.

The OSD circuit 15 processes video data based on character information or color information which it is instructed to output from the CPU 13, and outputs the processed video data as an OSD signal to the output processing unit 8. By the OSD circuit 15, an EPG (Electronic Program Guide) screen, a menu screen, a message, various types of setting screens, etc. can be displayed.

A remote control transmitter 17 comprises various types of keys, and sends out various types of commands to a digital broadcasting receiver 30. Signal light (a remote control signal) meaning a command corresponding to the operated key is sent out of a light emitting unit. A remote control light receiver 16 receives the signal light, converts the signal light into an electric signal, and feeds the electric signal to the CPU 13. In the present embodiment, keys numbered “1” through “12” which are provided in the remote control transmitter 17 are taken as allocation keys (hereinafter referred to as one-touch keys). Here, suppose a case where one broadcasting enterpriser performs broadcasting using one transport stream. In this case, one one-touch key corresponds to one broadcasting enterpriser. Further, an A/D (Analog Broadcasting/Digital Broadcasting) switching key (not shown) provided in the remote control transmitter 17 is operated. The keys numbered “1” through “12” are taken as analog channel selection keys when an analog broadcasting receiving mode is selected, while being taken as one-touch keys, as described above, when a digital broadcasting receiving mode is selected. A main body key 19 is provided, in part, with various types of keys.

A memory (a RAM, an EEPROM (Electrically Erasable and Programmable ROM) , a flash memory, etc.) 14 stores analog channel information (frequency information, information such as a channel list and an enterpriser name corresponding to a position), digital channel information (frequency information, information such as a channel list and an enterpriser name corresponding to a remote control key ID), EPG data, various types of setting information, etc.

Although the CPU 13 carries out overall control in the digital broadcasting receiver 30, channel searching processing, remote control key ID acquisition processing, analog broadcasting/digital broadcasting allocation processing for one-touch keys, simultaneous broadcasting judgment processing, receiving switching processing, message output processing, etc. are performed particularly as processing according to the present invention.

(Channel Searching Processing)

When the power is initially turned on, for example, the CPU 13 causes the digital tuner 2B to automatically tune in to the lowest frequency in a UHF (Ultrahigh Frequency) band in which terrestrial wave digital broadcasting is transmitted, to judge whether or not there exists a station. When it is judged that there exists a station, channel information (frequency information, station information, data representing a channel list (a group of channels), etc.) is extracted, and is stored in the memory 14. The processing is continued until the frequency is successively increased to the highest frequency (for example, from Channel 13 to Channel 62). Further, a table including a correspondence between an area code and a channel list receivable in an area having the area code is stored in the memory with respect to analog broadcasting, and the user enters the area code to select the channel list.

(Processing for Acquiring Remote Control Key ID)

In the case of the above-mentioned channel searching in digital broadcasting, the PSI is separated from the transport stream in the existent frequency, a remote control key ID in an NIT (Network Information Table) in the PSI is acquired, and is stored in the memory 14 in correspondence with the above-mentioned channel information or the like.

(Processing for Allocating One-touch Key)

Channel information for receiving the broadcasting is caused to correspond to the one-touch key having a number indicated by the acquired remote control key ID. That is, a broadcasting station A adds “1” as a remote control key ID to broadcasting and transmits the broadcasting having “1” added thereto, whereby the remote control key ID is acquired on the side of the receiver, and the broadcasting station A is set in the one-touch key “1” in the remote control transmitter 17. Thereafter, when the key “1” in the remote control transmitter 17 is pressed by the user, a channel in the broadcasting station A is selected.

(Channel Selection Processing Performed by Operating One-touch Key)

In a case where a digital broadcasting mode is selected by the above-mentioned operation of the A/D switching key, when the one-touch key “1” in the remote control transmitter 17 is pressed by the user, processing for selecting a channel of an enterpriser A is performed. Since a plurality of channels can be prepared at each of broadcasting stations in digital broadcasting, however, processing for selecting one of the channels in the above-mentioned channel list is performed. Here, it is considered that each of the broadcasting stations tends to make the number of the typical channel small (low) in the provided group of channels. Therefore, the channel to be first selected is set to the channel having the smallest number in the group of channels. If an attempt to select the other digital channel of the enterpriser A is made in this state, a channel UP/DOWN key in the remote control transmitter 17 may be operated.

On the other hand, in a case where an analog broadcasting mode is selected by the above-mentioned operation of the A/D switching key, when the one-touch key “1” in the remote control transmitter 17 is pressed by the user, Channel 1 in analog broadcasting is tuned in to.

(Simultaneous Broadcasting Judgment Processing)

When an analog broadcasting channel is selected, it is judged whether or not the same program as an analog broadcasting program which is being currently received is being broadcast in digital broadcasting at the present time. This judgment can be made by using information (a broadcasting enterpriser, the name of a program, the time when the program begins, etc.) described in EPG data in analog broadcasting, and information (a broadcasting enterpriser, the name of a program, the time when the program begins, etc.) described in a BIT (Broadcaster Information Table) and an EIT (Event Information Table) in digital broadcasting. That is, it can be judged whether or not the same program is being broadcast at the same time in both analog broadcasting and digital broadcasting by judging the coincidence of the information and the present time.

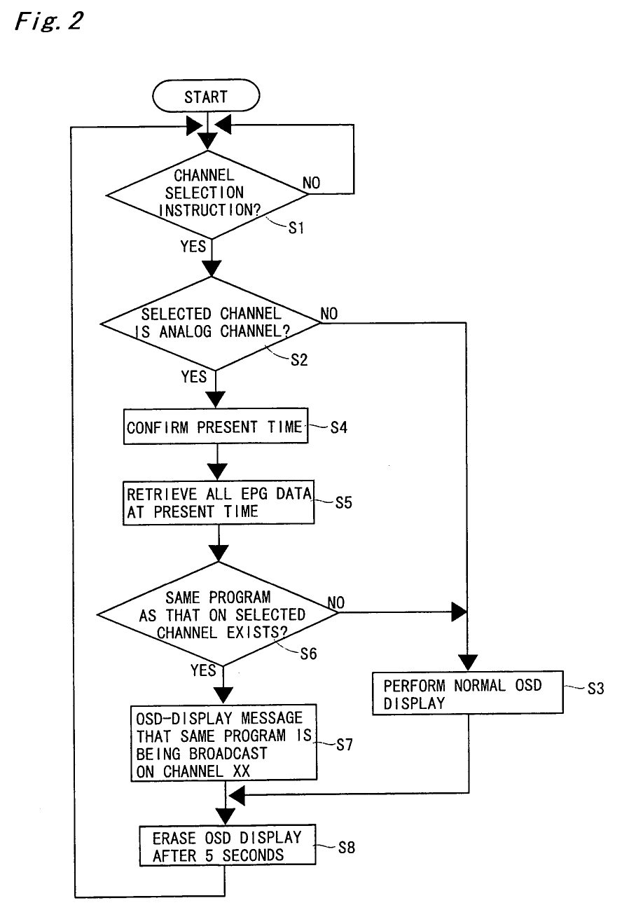

Processing performed in relation to simultaneous broadcasting will be then described. As shown in a flow chart of FIG. 2, it is judged whether or not there is a channel selection instruction (step S1). When the channel selection instruction is given, it is judged whether or not the selected channel is an analog broadcasting channel (step S2). When the selected channel is not an analog broadcasting channel, normal OSD display (display of a channel number and a broadcasting station name) is performed (step S3). On the other hand, when the selected channel is an analog broadcasting channel, the present time is confirmed (step S4), to retrieve all EPG data in digital broadcasting at the present time (step S5) It is judged whether or not the same program as a program which is being received on the selected analog broadcasting channel exists in digital broadcasting (step S6). Unless it exists, the procedure proceeds to the step S3. On the other hand, if it exists, a message that the same program is being broadcast in digital broadcasting is OSD-displayed (step S7). The message includes display of a channel number in digital broadcasting, or includes description “Operate a green button to switch to digital broadcasting”. Processing for erasing the OSD display is performed after five seconds (step S8).

When the user operates the green button provided in the remote control transmitter 17, for example, in a state where the OSD display is performed by the above-mentioned processing, an instruction to perform channel selection processing for viewing the same program in digital broadcasting is issued by the CPU 13, and an instruction to output to the multiplexer 7 a received video in digital broadcasting is issued by the CPU 13. Consequently, a receiving video in digital broadcasting of the same program is displayed on the screen. In a case where the message includes a channel number in digital broadcasting, the same program in digital broadcasting can be also viewed by operating the one-touch key corresponding to the number after switching to the digital broadcasting mode by operating the A/D switching key.

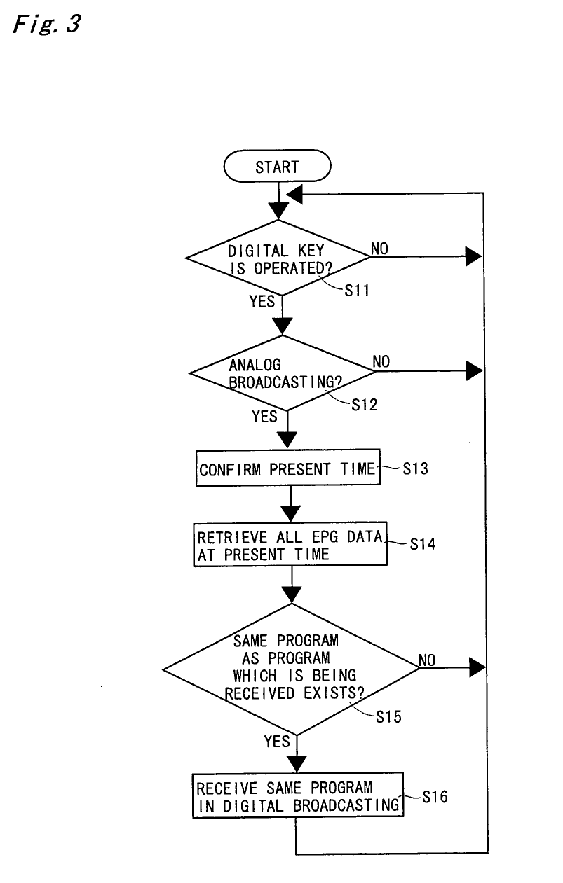

A flow chart of FIG. 3 shows another example of processing performed in relation to simultaneous broadcasting. The remote control transmitter 17 shall be provided with a predetermined key (herein named as a digital key). The user presses the digital key when he or she thinks “if simultaneous broadcasting is performed in digital broadcasting, I want to view a digital broadcasting program”. The CPU 13 judges whether or not the digital key is operated (step S11) . When the digital key is operated, it is judged whether or not there occurs a state where analog broadcasting is being received (step S12). When analog broadcasting is being received, the present time is confirmed (step S13), and all EPG data in digital broadcasting at the present time are retrieved (step S14). It is judged whether or not the same program as the program which is being received in the selected analog channel exists in digital broadcasting (step S15). If the same program exists, processing for receiving the same program in digital broadcasting is performed (step S16). On the other hand, when the answer is in the negative in the step S11, and the answer is in the negative in the step S12 (in the case of a state where digital broadcasting is being received or a stand-by state), or the answer is in the negative (there is no simultaneous broadcasting) in the step S15, the procedure proceeds to the step S11.

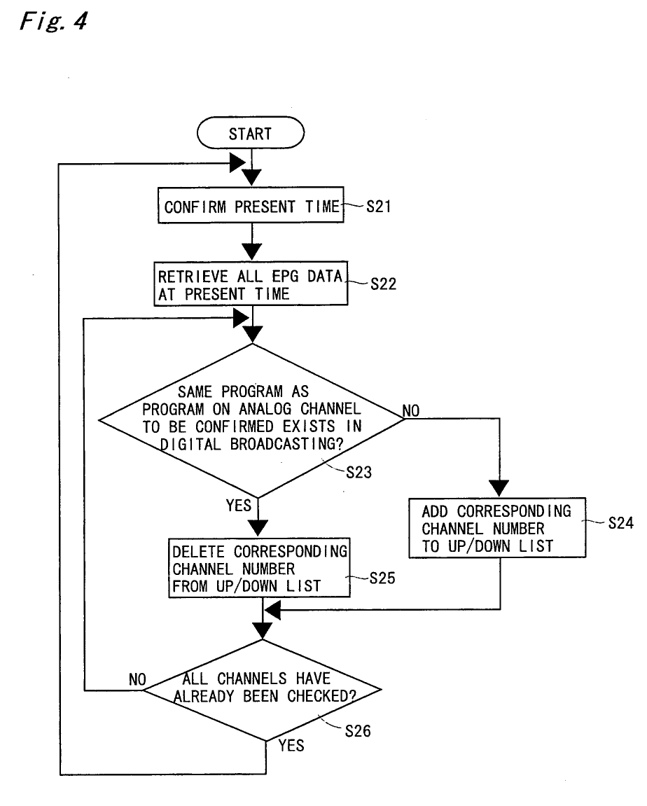

A flow chart of FIG. 4 shows another example of processing performed in relation to simultaneous broadcasting. Here, in a case where a channel UP/DOWN key in the remote control transmitter 17 is operated, for example, in the case of UP, there are a method of alternately selecting channels in digital broadcasting and channels in analog broadcasting, for example, performing sequential selection of a plurality of digital channels in the one-touch key “3”, analog broadcasting on Channel 3, sequential selection of a plurality of digital channels in the one-touch key “4”, and analog broadcasting on Channel 4 in this order, and a method of performing sequential selection of analog channels after sequential selection of all digital channels and performing sequential selection of digital channels after sequential selection of all analog channels. Although in normal setting, channel selection is performed, as described above, such setting that analog broadcasting in which the same program as that in digital broadcasting is being broadcast is not tuned in to by the above-mentioned operation of the UP/DOWN key can be used as special setting. In the flow chart of FIG. 4, the present time is confirmed during a program operation (step S21), and all EPG data in analog broadcasting and digital broadcasting at the present time are retrieved (step S22). It is judged whether or not the same program as a program broadcast on an analog channel to be confirmed exists in digital broadcasting (step S23). Unless it exists, the analog channel to be confirmed is added to an UP/DOWN list (step S24) . On the other hand, if it exists, the analog channel to be confirmed is deleted from the UP/DOWN list (step S25) It is judged whether or not all the channels have been checked. The procedure proceeds to the step S23 if the channels which have not been checked yet exist, while proceeding to the step S21 when all the channels have already been checked. By thus producing the UP/DOWN list, analog broadcasting in which the same program as that in digital broadcasting is being broadcast is not tuned in to by the above-mentioned operation of the UP/DOWN key. Consequently, a program in analog broadcasting can be prevented from being viewed without noticing the same program which is being broadcast in digital broadcasting.

Although in the above-mentioned example, a case where one broadcasting enterpriser performs broadcasting using one transport stream is assumed, and one broadcasting enterpriser corresponds to one one-touch key in this case, the present invention is not necessarily limited to the selection of a broadcasting enterpriser with a one-touch key if consideration is given to a case where one broadcasting enterpriser (broadcasting station) performs broadcasting using a plurality of transport streams or inversely given to a case where a plurality of broadcasting enterprisers (broadcasting stations) exist in one transport stream. For example, a group of channels in one or two or more transport streams may be taken as one group. That is, it may be arbitrarily determined in what group unit a one-touch key is set in correspondence with judgment in what form broadcasting is being performed.

Although it is assumed that all EPG data in digital broadcasting are retrieved, only the EPG data in digital broadcasting of a broadcasting enterpriser corresponding to a selected analog channel may be retrieved.

As described in the foregoing, according to the present invention, various effects are produced. For example, a user is urged to view programs in digital broadcasting as much as possible in a case where the same program is being broadcast using simulcast in analog broadcasting and digital broadcasting. Further, a user can be prevented from viewing a program in analog broadcasting without noticing the same program which is being broadcast in digital broadcasting.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A broadcasting receiver comprising:
an analog broadcasting receiving unit for receiving analog broadcasting;
a digital broadcasting receiving unit for receiving digital broadcasting;
means for acquiring information as to whether or not the same program is being broadcast in analog broadcasting and digital broadcasting, to judge whether or not there is simulcast; and
means for displaying on a screen a message that the same program is being broadcast in digital broadcasting when analog broadcasting in simulcast is being received.

2. The broadcasting receiver according to claim 1, wherein
digital broadcasting in simulcast is received when a predetermined key is operated in a state where said message is displayed.

3. A broadcasting receiver comprising:
an analog broadcasting receiving unit for receiving analog broadcasting;
a digital broadcasting receiving unit for receiving digital broadcasting;
means for acquiring information as to whether or not the same program is being broadcast in analog broadcasting and digital broadcasting, to judge whether or not there is simulcast; and
means for switching, in a case where analog broadcasting in simulcast is being received, the receiving of analog broadcasting in simulcast to the receiving of digital broadcasting in simulcast when a predetermined key is operated.

4. In a broadcasting receiver configured such that a channel can be changed by comprising a channel UP/DOWN key, a broadcasting receiver comprising
an analog broadcasting receiving unit for receiving analog broadcasting;
a digital broadcasting receiving unit for receiving digital broadcasting;
means for acquiring information as to whether or not the same program is being broadcast in analog broadcasting and digital broadcasting, to judge whether or not there is simulcast; and
means for erasing an analog channel on which analog broadcasting in simulcast is being performed at the present time on the basis of an internal clock from a list in said channel UP/DOWN key.
